(19) United States
(12) Patent Application Publication
(10) Pub. No.: US 2012/0265989 A1
(43) Pub. Date: Oct. 18, 2012

(54) SECURE LOGIN METHOD

(75) Inventors: Cheng-Hsun Lee, Taipei (TW); Hsiang-Po Wang, Taipei (TW); Yu-Hsin Lai, Taipei (TW)

(73) Assignee: CHUNGHWA TELECOM CO., LTD., Taipei (TW)

(21) Appl. No.: 13/224,438

(22) Filed: Sep. 2, 2011

(30) Foreign Application Priority Data
Apr. 14, 2011 (TW) 100112929

(51) Int. Cl. H04L 9/32

(52) U.S. Cl. 713/168

(57) ABSTRACT

The present invention provides a secure login method, including connecting a user end to a server end via internet and accessing user end information by the server end; generating or selecting an algorithm corresponding to the user end information by the user end according to a predetermined rule; and providing a website page to the user end by the server end, and encrypting information entered into the website page by the algorithm provided via the website page and to storing the encrypted information in the user end. While the user end is re-connected to the server end and logins the server end, the website provided to the user end uses the algorithm to decrypt the encrypted information stored in the user end, and the decrypted information is entered into the website page. Accordingly, the present invention prevents hackers from stealing others' cookies, so as to secure the user's information.

### BACKGROUND OF THE INVENTION

1. Field of the Invention

The present invention relates to secure login methods, and more particularly, to a secure login method for preventing cookies at a local end from being stolen.

2. Description of Related Art

A cookie is stored on a user's computer by a web browser for authentication.

It is common that a website designer uses cookie technology for storing an account or a password of a user. When a user logins an information website at his/her first time, the user's account and password are stored in the cookie at the user end by JavaScript and encryption algorithm. When the user re-logins this information website, the cookie is automatically read by JavaScript, the account and password are decrypted by a specific decryption algorithm and automatically entered at columns of the account or password on the web page, so as to eliminate re-input of user's information and to facilitate the user to login the website. In addition, a cookie is commonly applied for a shopping cart at a shopping website, wherein users select different products on different web pages at the same website, all text messages are stored as cookies such that the messages are accessed at checkout.

However, cookies may damage privacy and security of users. If the cookie is stolen, the user's name, the computer's name and browsed information are revealed as well. Generally, hackers use cross-site scripting (XSS) to steal users' cookies, and copy the cookies at hackers' end to further steal users' accounts or passwords.

JavaScript program may be closed to prevent cookies from being stolen; however, many websites use JavaScript program, such that the web pages cannot be browsed due to the JavaScript program is closed. In addition, websites use a variety of programs to prevent hackers from stealing cookies which cause inconvenience to users while logging the websites. For example, US Patent Applicant Publication No. 20080263650 discloses authorization information and mechanisms for identifying whether users are authorized. When authorized, users may enter the protected pages; however, when not authorized, users enter portal sites, so as to prevent unauthorized users (such as hackers) from entering the protected pages and from performing XSS and the like. Further, session may be applied to prevent cookies from being stolen, but may cause overload to the server.

### SUMMARY OF THE INVENTION

The present invention provides a secure login method for preventing cookies at a local end from being stolen.

The secure login method of the present invention includes the following steps: (1) connecting a user end to a server end via the Internet and accessing user end information by the server end; (2) generating or selecting an algorithm corresponding to the user end information by the user end according to a predetermined rule; and (3) when providing a website page to the user end by the server end, encrypting information entered into the website page by the algorithm provided via the website page, and storing the encrypted information at the user end.

In an aspect of the present invention, the secure login method further includes the steps of: (4) identifying whether the user end is re-connected to the sever end, and if the user end is re-connected to the sever end, accessing the user end information by the server end and generating or selecting the algorithm corresponding to the user end information according to the predetermined rule; and (5) providing the website page to the user end by the server end, decrypting the encrypted information stored at the user end, and entering the decrypted information at the website page.

In an aspect of the present invention, step (1) of the secure login method further includes: (1-1) obtaining and storing the user end information including the circuit information and the media access control address by an authentication module via a gateway, and assigning Internet address to the user end by an Internet address assign module; and (1-2) connecting the user end to the server end via the Internet address assigned to the user end, and accessing the user end information from the authentication module according to the Internet address of the user end.

In an aspect of the present invention, step (2) of the secure login method further includes storing the algorithm by the server end, and the secure login method further includes (4) identifying whether the user end is re-connected to the sever end, and if the user end is re-connected to the sever end, accessing the user end information by the server; and (5) accessing the algorithm by the server end according to the user end information, providing the website page to the user end by the server end, using the algorithm corresponding to the user end information to decrypt the encrypted information stored at the user end, and entering the decrypted information at the website page.

The user end information may be internet equipment serial number, internet card number, virtual local area internet information, media access control address or circuit information at the user end.

In comparison with the prior art, the secure login method of the present invention prevents hackers from stealing cookies of the user end by XSS technology, has no need to close JavaScript program, and has no interference while browsing websites. In addition, the secure login method of the present invention is performed without layers of authentications and sessions and thereby avoids overload of the server end.

### BRIEF DESCRIPTION OF THE DRAWINGS

FIG. 1A is a flow chart showing the secure login method according to the first embodiment of the present invention;

FIG. 1B is a schematic view showing the secure login method according to the first embodiment of the present invention;

FIG. 1C is a flow chart showing the secure login method according to the second embodiment of the present invention;

FIG. 2A is a flow chart showing the secure login method according to the third embodiment of the present invention;

FIG. 2B is a schematic view showing the secure login method according to the third embodiment of the present invention;

FIG. 3A is a flow chart showing the secure login method according to the fourth embodiment of the present invention; and

FIG. 3B is a schematic view showing the secure login method according to the fourth embodiment of the present invention.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

### The First Embodiment

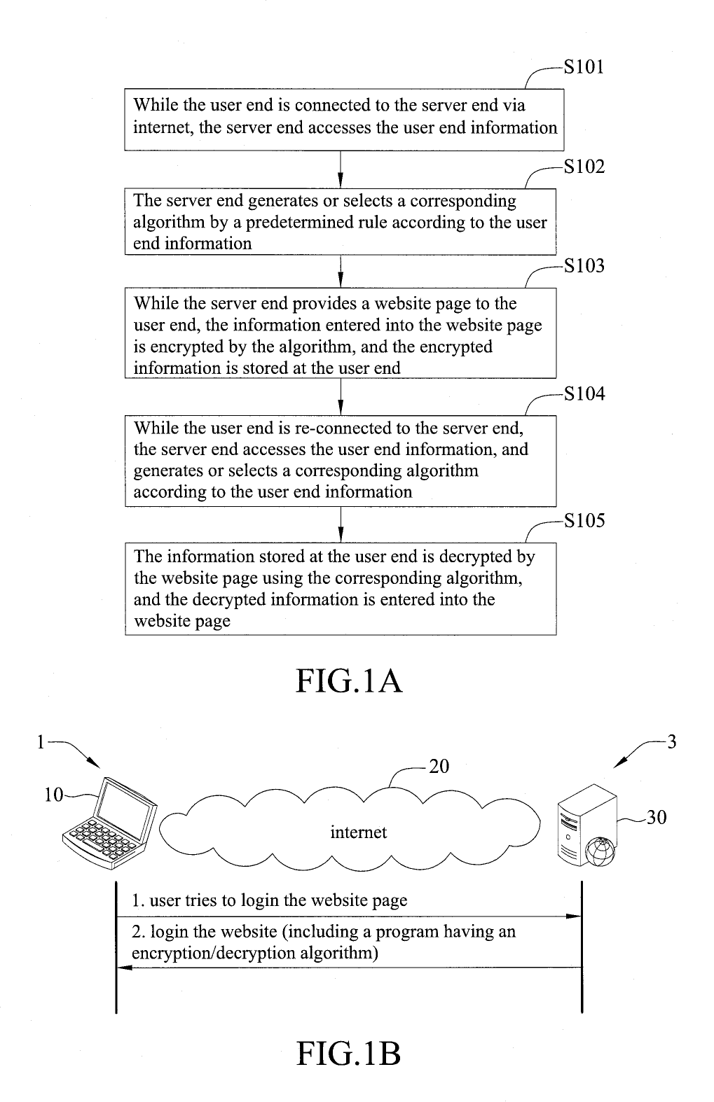

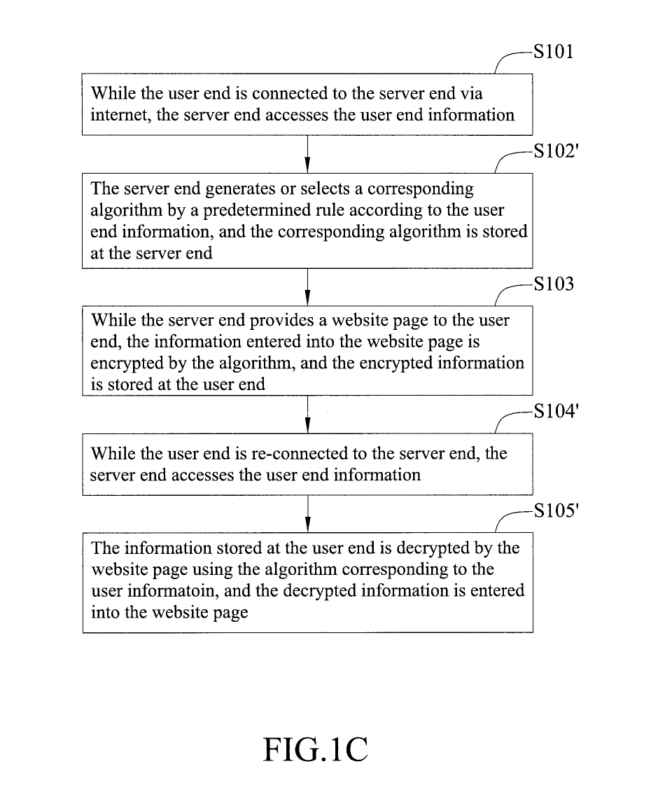

Referring to FIG. 1A and FIG. 1B, FIG. 1B is a schematic view showing the secure login method shown in FIG. 1A.

In step S101, a user end 1 using a user end device 10 is connected to a server end 3 via internet 20, and the user end information is accessed by the server end 3, wherein the user end information may be internet equipment serial number, internet card number, virtual local area internet information, media access control address, circuit (such as wiring for XDSL) formation and the like. Further, the server 3 may access the virtual local area network or media access control address of the user end 1 via a data link layer (layer 2) of the Internet 20. The secure login method of the present invention can use one or a plurality of same or different user end information in different embodiments, such that the secure login method of the present invention is allowed to be applied in different environments to enhance security of user end information. Then, step S102 is performed.

In step S102, the server end 3 generates or selects an algorithm corresponding to the accessed user end information by a predetermined rule. For example, the server end 3 may use the virtual local area internet information or media access control address of the user end 1 as a factor to generate a specific algorithm. Alternatively, the server end 3 may select a specific algorithm from multiple algorithms in the server end 3 according to the virtual local area internet information or media access control address of the user end 1. The algorithm may be conventional, commercially available, or user-developed encryption technology. Then, step S103 is performed.

In step S103, while a server 30 of the server end 3 provides a website page to the user end 1, the information entered into the website page by the user end device 10 is encrypted according to the algorithm provided by the website page, and stored in the user end device 10. For example, an account and a password of an email account are entered on an email login website by the user end device 10 of the user end 1, and the email login website has a program (such as JavaScript program) for executing the algorithm. Thus, while the account and the password of the email account are entered on the email login website by the user end device 10 of the user end 1, cookies of the account and the password are encrypted and stored in the user end device 10.

After performing steps S101 to S103, if cookies stored in the user end 1 are stolen, hacker who stole the cookies cannot use the cookies without decryption algorithm since the cookies have been encrypted by the specific algorithm. Therefore, the cookies in the user end 1 are secured and protected.

In this embodiment, steps S104 and S105 are performed.

In step S104, it is identified whether the user end 1 is re-connected to the server end 3. If the user end 1 is re-connected to the server end 3, the server end 3 re-accesses the user end information at the user end 1, and generates or selects the algorithm corresponding to the user end information according to the user end information and a predetermined rule. Then, step S105 is performed.

In step S105, while the server 30 of the server end 3 re-provides a website page to the user end 1, the encrypted information stored in the user end device 10 of the user end 1 is decrypted by using the algorithm corresponding to the user end information, and the decrypted information is then entered into the website page. As described above, in this embodiment, while the user end 1 is reconnected to the server end 3 via the user end device 10, the server 30 of the server end 3 re-provides the website page to the user end 1 for entering the account and the password, and decrypts the cookie of the user end device 10 by using the corresponding algorithm generated or selected by the server end 3. Then, the account and the password previously set by the user end 1 may be used.

In comparison with the prior art, the secure login method of the present invention not only increases steps for protecting cookies at the user end 1, but also protects cookie information.

### The Second Embodiment

Referring to FIG. 1C, this embodiment is similar to the first embodiment except that in step S102′. In step S102′, the server end 3 generates or selects the encryption algorithm corresponding to the cookie by the predetermined rule according to the user end information, and also stores the corresponding algorithm, such that in step S104′, while the user end 1 is reconnected to the server end 3, the server end 3 re-accesses the user end information of the user end 1, and generates or selects the corresponding algorithm by the predetermined rule according to the user end information. Then, step S105′ is performed.

In step S105′, the server end 3 provides the algorithm, which is corresponding to the user end information, to the website page of the user end 1 to decrypt the cookie information stored in the user end 1, and then the decrypted information is entered into the website page.

In light of the first and the second embodiments, the secure login method of the present invention encrypts the information entered into the website page of the user end. Therefore, even though hackers obtain the encrypted information in the cookie, the encrypted information cannot be decrypted due to the user end information is not obtained, such that the account and the password cannot be stolen.

The following embodiments are variations of that disclosed in FIG. 1A.

### The Third Embodiment

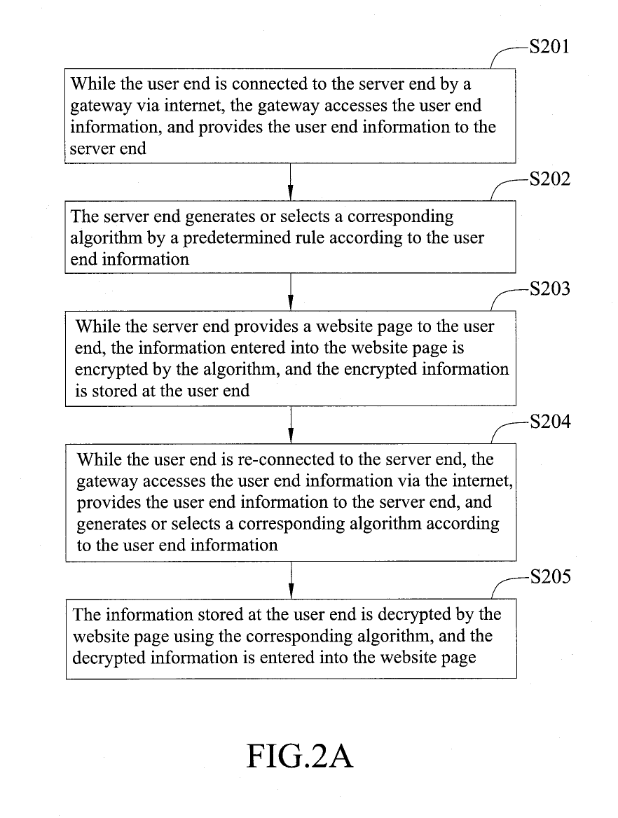

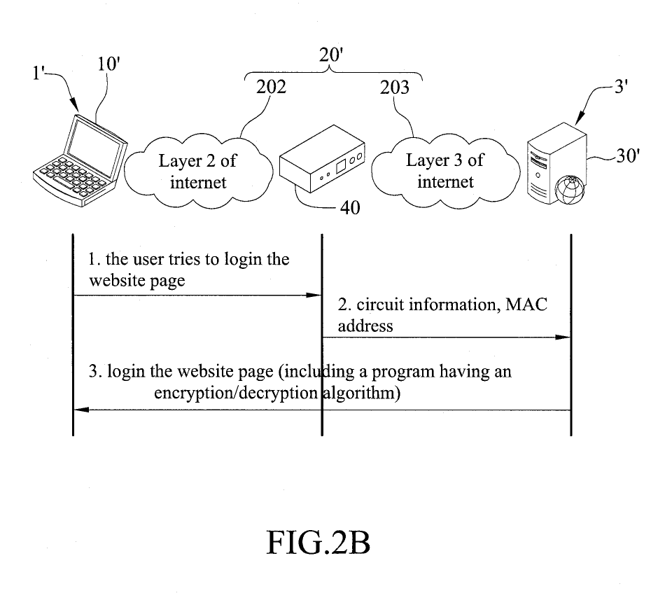

Referring to FIG. 2A and FIG. 2B, in step S201, the user end 1′ is connected to the server end 3′ by the user end device 10′ via the gateway 40 through the Internet 20′. The gateway 40 accesses the user end information of the user end 1′ via the data link layer (layer 2) 202 of the Internet 20′, and provides the user end information to the server end 3′ via the network layer (layer 3) 203 of the Internet 20′. The user end information accessed from the user end 1′ includes the media access control address, and the user end information provided to the server end 3′ includes the circuit information. Then, step S202 is performed.

In step S202, the server end 3′ generates an algorithm corresponding to the user end information including the media access control address and circuit information by a predetermined rule, or randomly selects an algorithm corresponding to the user end information including the media access control address and circuit information. Then, step S203 is performed.

In step S203, while the server 30′ of the server end 3′ provides the website page to the user end 1′, the information entered into the website page by the user end device 10′ of the user end 1′ is encrypted by the algorithm, and the encrypted information is stored as the cookie in the user end device 10′. Then, step S204 is performed.

In this embodiment, steps S204 and S205 are further performed.

In step S204, while it is identified that the user end 1′ is re-connected to the server end 3′, the server end 3′ accesses the user end information as the way in steps S201 and S202, and generates the algorithm corresponding to the user end information by the predetermined rule or randomly selects the algorithm corresponding to the user end information. Then, step S205 is performed.

In step S205, the cookie stored in the user end device 10′ is decrypted by the corresponding algorithm, and the decrypted information is entered into the website page.

### The Fourth Embodiment

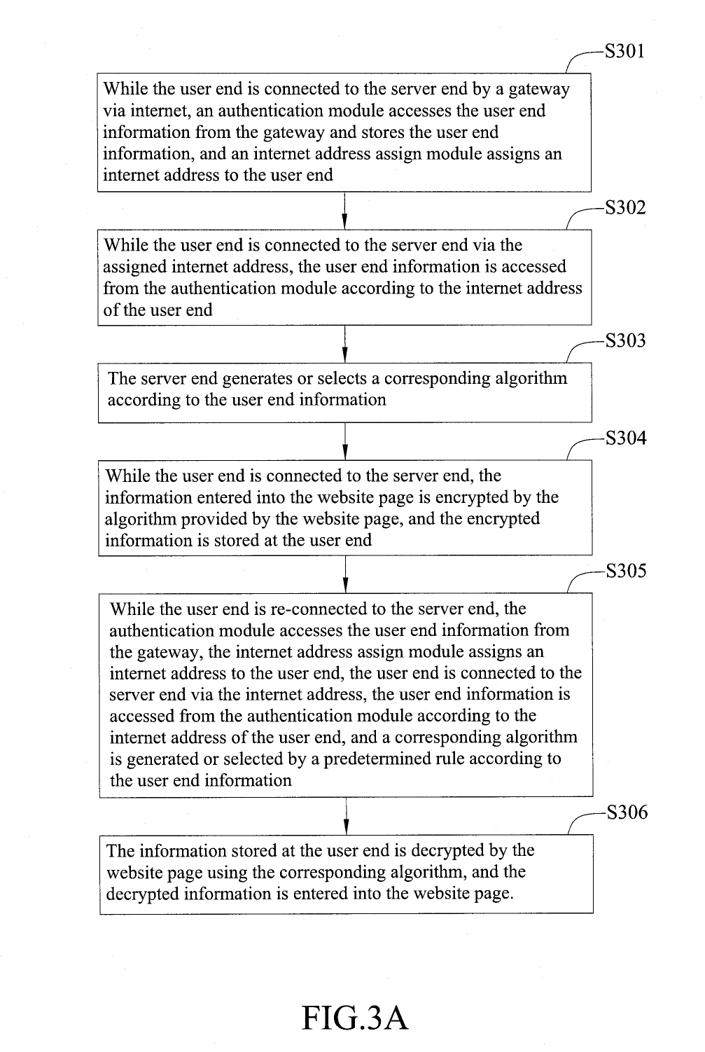

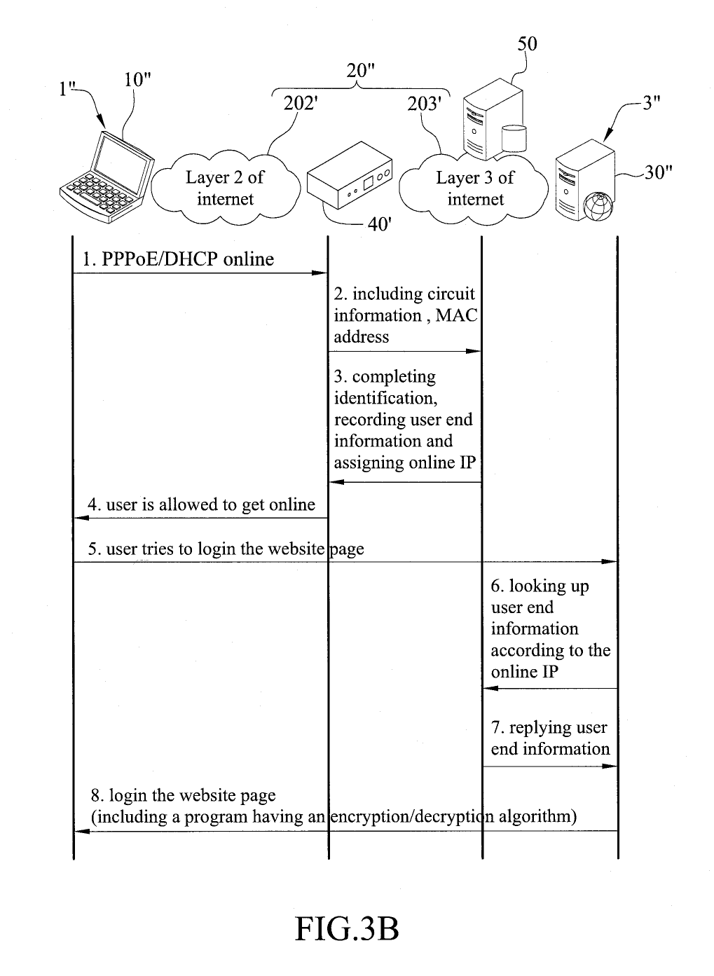

Referring to FIG. 3A and FIG. 3B, this embodiment is similar to the third embodiment. The user end 1″ is connected to the server end 3″ by the user end device 10″ via the gateway 40′ through the Internet 20″, wherein the gateway 40′ accesses the user end information of the user end 1″ via the data link layer (layer 2) 202′ of the internet 20″, and provides the user end information to the server end 3″ via the network layer (layer 3) 203′ of the Internet 20″. The user end information provided by the gateway 40′ to the server end 3″ includes circuit information and media access control address. This embodiment is different from the third embodiment in that the server end 3″ further includes a server 30″, an authentication module 50 and an Internet address assign module (not shown). Specifically, the authentication module 50 and the Internet address assign module may be integrated in Internet service provider (ISP) platform. In addition, the user end 1″ may use point to point protocol over Ethernet (PPPoE) or dynamic host configuration protocol (DHCP).

In step S301, while the user end 1″ is connected to the server end 3″ by the user end device 10″ via the gateway 40′ through the Internet 20″, the authentication module 50 accesses the user end information including the circuit information and/or the media access control address from the gateway 40′, and stores the user end information, wherein the user end 1″ is identified by the authentication module 50 while the user end 1″ is connected to the server end 3″. For example, the account, the password, the circuit information or the media access control address entered from the server end is identified, and then an internet address is assigned to the user end 1″ by the Internet address assign module.

In step S302, while the user end 1″ is connected to the server end 3″ via the assigned Internet address, the user end information of the user end 1″ is accessed from the authentication module 50 according to the Internet address of the user end 1″.

In step S303, the server end 3″ generates a corresponding algorithm by a predetermined rule according to the user end information, or selects a corresponding algorithm according to the user end information.

In step S304, while the server 30″ of the user end 3″ provides a website page to the user end 1, the information entered into the website page by the user end device 10″ of the user end 1″ is encrypted by the algorithm provided by the website page, and the encrypted information is stored as a cookie in the user end device 10″.

In step S305, while the user end 1″ is re-connected to the server end 3″, the server end 3″ accesses the user end information according to steps S301 to S303, and generates the corresponding algorithm by the predetermined rule or randomly selects the corresponding algorithm. Then, step S306 is performed.

In step S306, the website page uses the corresponding algorithm to decrypt the cookie stored in the user end device 10″, and the decrypted information is entered into the website page.

In light of the third and the fourth embodiments, while the secure login method of the present invention stores an account and a password of a user by using cookie technology, an algorithm may be generated or selected in response to different Internet installations such as MAC address and/or circuit information to encrypt/decrypt the account and the password of the user, such that hackers cannot steal others' cookies and cannot login the website page.

Accordingly, the secure login method of the present invention generates or selects a corresponding algorithm according to the user end information such as the Internet equipment serial number, Internet card number, virtual local area Internet information, media access control address and/or circuit information of the user end, the website page provided to the user end uses the algorithm to encrypt the information entered into the website page, and the encrypted information is stored as a cookie in the user end device. Further, the cookie is decrypted by the algorithm. Therefore, hackers cannot steal the cookie and login the website page.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A secure login method, comprising the steps of:
(1) connecting a user end to a server end via the Internet for accessing user end information at the user end by the server end;
(2) generating or selecting an algorithm corresponding to the user end information by the server end according to a predetermined rule; and
(3) when providing a website page to the user end by the server end, encrypting information entered into the website page by the algorithm provided via the website page and then storing the encrypted information at the user end.

2. The secure login method of claim 1, further comprising the steps of:
(4) identifying whether the user end is re-connected to the sever end, and if the user end is re-connected to the sever end, accessing the user end information at the user end by the server end and generating or selecting the algorithm corresponding to the user end information according to the predetermined rule; and
(5) providing the website page to the user end by the server end, using the algorithm to decrypt the encrypted information stored at the user end, and entering the decrypted information into the website page.

3. The secure login method of claim 1, wherein step (1) comprises accessing the user end information by the server end via a data link layer of the Internet.

4. The secure login method of claim 3, wherein the user end information is virtual local area network information or media access control address.

5. The secure login method of claim 1, further comprising connecting the user end to the server end via the Internet through a gateway, wherein step (1) further comprises accessing the user end information by the gateway via the data link layer of the Internet and providing the user end information to the server end via a network layer of the Internet.

6. The secure login method of claim 5, wherein the user end is connected to the server end via point to point protocol or dynamic host configuration protocol.

7. The secure login method of claim 5, wherein the gateway provides the user end information including circuit information and media access control address to the server end.

8. The secure login method of claim 7, wherein the server end has an authentication module and an Internet address assign module, and step (1) comprises the steps of:
(1-1) obtaining and storing the user end information including the circuit information and the media access control address by the authentication module via the gateway, and assigning Internet address to the user end by the Internet address assign module; and
(1-2) connecting the user end to the server end via the Internet address assigned to the user end, and accessing the user end information from the authentication module according to the Internet address of the user end.

9. The secure login method of claim 8, wherein step (1-1) further comprises:
performing identity authentication to the user end while connecting the user end to the server end.

10. The secure login method of claim 1, further comprising storing the algorithm corresponding to the user end information by the server end in step (2), and subsequent to step (3), further comprising the steps of:
(4) identifying whether the user end is re-connected to the sever end, and if the user end is re-connected to the sever end, accessing the user end information by the server end; and
(5) accessing the algorithm by the server end according to the user end information, providing the website page to the user end by the server end, using the algorithm corresponding to the user end information to decrypt the encrypted information stored at the user end, and entering the decrypted information at the website page.

11. The secure login method of claim 1, wherein the user end information is Internet equipment serial number, internet card number, virtual local area Internet information, media access control address or circuit information at the user end.
